(19) United States
(12) Patent Application Publication
(10) Pub. No.: US 2010/0186902 A1
(43) Pub. Date: Jul. 29, 2010

(54) LABELING APPARATUS HAVING A PIVOTABLE BASE PLATE WITH FEED WHEEL

(75) Inventor: Michael Baumbusch, Hirschhorn (DE)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: CHECKPOINT SYSTEMS INTERNATIONAL GMBH, Heppenheim (DE)

(21) Appl. No.: 12/693,901

(22) Filed: Jan. 26, 2010

Related U.S. Application Data
(60) Provisional application No. 61/147,652, filed on Jan. 27, 2009.

(51) Int. Cl. B65C 9/18; B32B 7/12

(52) U.S. Cl. 156/541; 428/42.3

(57) ABSTRACT

The present invention is directed to a labeling apparatus designed to dispense and apply self-adhesive labels arranged on a carrier web, a base plate suitable therefor and a label web. A feed wheel for the carrier web is rotatably mounted on the base plate and has at both its end faces a ring of axial pins engageable by an operating lever pivotally mounted on a casing of the labeling apparatus in order to drive the feed wheel in increments. The feed wheel has a generating surface with two rings of radial projections in the form of knobs adapted to make positive engagement with recesses or cutouts of the carrier web. Instead of using knobs as projections, it is also possible to provide sprockets on the feed wheel which are adapted to make positive engagement with slits in the carrier web. The base plate is configured as an interchangeable base plate which is selectable in dependence upon the phase relationship of the rings of projections to the rings of axial pins of the feed wheel.

### CROSS-REFERENCE TO RELATED APPLICATIONS

This utility application claims the benefit under 35 U.S.C. §119(e) of Provisional Application Ser. No. 61/147,652 filed on Jan. 27, 2009 entitled LABELING APPARATUS HAVING A PIVOTABLE BASE PLATE WITH FEED WHEEL and whose entire disclosure is incorporated by reference herein.

### BACKGROUND OF THE INVENTION

1. Field of Invention

This invention relates to a labeling apparatus designed to dispense and apply self-adhesive labels arranged on a carrier web in which a feed wheel for the carrier web is rotatably mounted on a base plate and drivable in increments by an operating lever pivotally mounted on a casing of the labeling apparatus, in which the feed wheel has a generating surface with at least one ring of radial projections for positive engagement with the carrier web and has at both its end faces a ring of axial pins engageable by a feed pawl pivotal by the operating lever, and in which the base plate is configured to be swung away from the casing.

Further, the invention relates to a base plate of the afore-mentioned labeling apparatus. Still further, the invention relates to a label web for a labeling apparatus with such a base plate.

2. Description of Related Art

A labeling apparatus of the kind referred to above is known from the document EP 0 039 803 A1. A labeling apparatus with a label web of the kind referred to above is known from the document DE 103 58 318 A1. The label web comprises a carrier web on which self-adhesive labels are carried.

The labeling apparatuses disclosed in the two above-mentioned documents include a tongs-type, hand-operated device in which the labels with their carrier web are unwound from a label supply spool by a feed mechanism, advanced through a print mechanism and then fed to a dispensing lip where the labels are delaminated from the carrier web one by one and paid out. The feed mechanism and the print mechanism for printing on the label are driven by a pivotally mounted operating lever. This operating lever is arranged opposite a handle rigidly mounted on the casing. Using a swinging-in motion of the operating lever against the force of a spring, the print mechanism is moved against a platen for printing on a label resting on the platen.

In the labeling apparatus disclosed in DE 103 58 318 A1, when the operating lever is swung back by spring force, the carrier web is held clamped between a clamping member of a feed pawl and a table of a transport slide and advanced by the transport slide by one label pitch. After the printed label has delaminated itself from the carrier web at the dispensing lip, it is applied to an object to be labeled by means of an applicator roll.

In the labeling apparatus disclosed in EP 0 039 803 A1, a feed wheel used in lieu of the transport slide is mounted for rotation on a base plate and includes a generating surface with a ring of radial projections constructed as sprockets and engaging in prefabricated slits of the carrier web for advancing the label web after the labels preceding these slits are applied to an object to be labeled.

For control of the labeling apparatus disclosed in DE 103 58 318 A1 which ensures that each label reaches the print mechanism and the dispensing lip in its proper position, the longitudinal edges of the carrier web which exhibit a special contour are traced. The proper position of the label web in the print mechanism is then ensured by the transport slide. By contrast, in the labeling apparatus disclosed in EP 0 039 803 A1, the proper position is ensured by the feed wheel whose sprockets engage the slits of the carrier web.

A labeling apparatus of the type known from EP 0 039 803 A1 is only able to handle slitted webs of label material. While a labeling apparatus of the type known from DE 103 58 318 A1 is designed to handle label webs whose longitudinal edges exhibit a particular contour, these label webs may be additionally provided with slits to enable them to be used with a labeling apparatus of the aforementioned type which includes a feed wheel with sprockets. In the long run, a feed mechanism using a feed wheel basically operates more reliably than a feed mechanism using a transport slide since the latter' s function may be impaired by paper shreds. On the other hand, the slits required for engagement of the sprockets of the feed wheel may impair the appearance of the label. A particular problem is the fixed length of feed in both known types of labeling apparatus, which is the reason why only labels of a specified length can be processed. In addition, this also prevents the possibility for the dispensing position to be adjusted or corrected, for example in order for the print mechanism to effect printing precisely in a preprinted zone of the label. Moreover, the feed mechanism with slide is only suitable for use with one particular type of label in which the label pitch is in a defined phase relationship to the pitch of the outer contour of the longitudinal edges of the carrier web. Accordingly, for any other label format and/or any other label length a different labeling apparatus is required in the prior art.

To eliminate this problem, a labeling apparatus according to DE 38 43 113 A1 should therefore be able to accommodate different label lengths. In this labeling apparatus, an operating lever for driving a feed wheel provided with sprockets, rather than acting directly on a rack coupled to it by a pinion, is moved to swivel a two-armed swivel lever which in turn effects displacement of the rack. By interposing the swivel lever in the driving connection, a relatively large or relatively small displacement of the rack and thus a correspondingly large or small angle of rotation of the feed wheel should be produced. In this manner, the labeling apparatus should be suitable for applications involving labels of different lengths. However, this can be accomplished within limits only, because on a label web with feed slits the slits are prefabricated such as to be located at the parting line between two labels. On a label web including labels of a different length the slits between labels have to be spaced differently. If the slits were prefabricated anywhere within the label area, they would adversely affect the print image. Furthermore, interposition of the swivel lever allows neither adjustment nor correction of the dispensing position.

All references cited herein are incorporated herein by reference in their entireties.

### BRIEF SUMMARY OF THE INVENTION

It is an object of the present invention to provide a labeling apparatus of the type initially referred to in such a way that different label webs which may include labels of different shape can be handled. Furthermore, it is desirable to provide a base plate suitable in particular for such a labeling apparatus and a suitable label web.

According to the invention, this object is accomplished by

a labeling apparatus characterized in that the radial projections are provided in two axially spaced rings on the generating surface of the feed wheel, said projections lying opposite each other in pairs and being adapted to make positive engagement with recesses or cutouts of the carrier web, and that the base plate is configured as an interchangeable base plate and is selectable in dependence upon the phase relationship of the rings of projections to the rings of pins of the feed wheel;

a base plate; and

a label web characterized in that the phase relationship of the pitch of the carrier web to the pitch of the strip of individual labels arranged on the carrier web is chosen such that each pair of recesses of the carrier web lies in the center between two straight and parallel boundary lines of each label which extend in a direction transverse to the longitudinal direction of the carrier web.

The labeling apparatus according to the present invention retains the principle known from EP 0 039 803 A1 according to which the base plate is configured to be able to swing away from the casing for ease of access to all the parts mounted on the base plate if and when required. According to the present invention, the radial projections for advancing the carrier web are arranged and configured such as to make positive engagement with recesses or cutouts of the carrier web. Furthermore, according to the present invention the base plate is configured to be an interchangeable base plate which can be readily replaced with an interchangeable base plate mounting a different feed wheel when required. In the base plate of the labeling apparatus according to the present invention the position of the labels relative to the recesses or cutouts of the label web may vary. Allowance for this can be made simply by selecting a feed wheel on which the rings of projections are arranged in a defined phase relationship to the rings of pins through which the feed wheel is driven. Considering that only the feed wheel changes from one interchangeable base plate to the next, it would also be conceivable to replace only the feed wheel while retaining the interchangeable base plate. Conveniently, however, the base plate according to the present invention is configured to be a disposable item which, when required, is simply replaced with a base plate having a similar or a dissimilar feed wheel. In either case, the base plate of the labeling apparatus according to the present invention also enables label webs to be handled which have a wavy or serrated outer contour along their longitudinal edges and/or cutouts in the form of slits. The shape of the label can be selected, for example, by placing it with its center axis onto the center axis between two recesses or two elevations of the carrier web or to any position in-between. Allowance for the one or the other case is made by using a base plate according to the present invention with a corresponding feed wheel on which the ring of pins for driving the feed wheel is in a defined phase relationship to the ring of projections. In the period around 1970/71, applicant manufactured a handheld labeler (Meto 105 type) which included a feed wheel with rings of knobs at the axial ends of its generating surface, but this one was fixedly installed in the interior of the handheld labeler and therefore not accessible.

The label web according to the present invention for a labeling apparatus with a base plate according to the present invention enables the label shape to be varied in a convenient way by selecting the phase relationship of the pitch of the carrier web to the pitch of the strip of individual labels arranged on the carrier web to be correspondingly selected, for example by arranging each pair of elevations or recesses of the carrier web, instead of in the center, in displaced relation to the center between two straight and parallel boundary lines of each label which extend face in a direction transverse to the longitudinal direction of the carrier web.

In one aspect of the present invention a return stop is used for the feed wheel, which return stop comprises cams formed on the feed wheel and a detent spring protruding from the base plate and engageable with the cams. Each feed wheel, related to the associated label shape, can be easily adapted to the return stop by selecting the phase angle of the cams of the return stop in conformity with the phase angle of the pins provided for driving the cam wheel. In this arrangement, the detent spring can be a spring arm formed on the base plate, which enables it to be manufactured with the base plate in simple manner.

In another aspect of the present invention the feed wheel has in its generating surface a central annular recess in which the cams are formed at the bottom. Therefore, its proper relation to the return stop can be re-established easily when a feed wheel is replaced.

In a further aspect of the present invention the inner side of the base plate includes at least one deflector for the carrier web, which deflector is configured to extend obliquely upwardly into the central annular recess of the feed wheel so that guidance of the carrier web can be ensured in simple manner on its leaving the feed wheel and the base plate.

In a further aspect of the present invention the base plate includes two axle stubs integrally formed at its one end face, which stubs are snap-fittable into associated bores in mutually opposite sidewalls of the casing and are rotatable in said bores for swinging the base plate away so that the base plate is easily releasable from the casing for replacement by temporarily urging the sidewalls slightly apart in the area of the axle stubs, or by temporarily pressing the end faces of the base plate carrying the axle stubs slightly together.

In a further aspect of the present invention the feed wheel includes axle stubs at its end faces which are snap-fitted into associated bores in mutually opposite sidewalls of the base plate so that the feed wheel can be mounted or demounted easily by temporarily urging the sidewalls of the base plate slightly apart.

In a further aspect of the present invention the base plate pivotally mounts a web guide which covers the feed wheel in a semicircle and can be swung away from the feed wheel so that it is ensured that the carrier web wraps around the feed wheel closely on its advancing movement, while yet the feed wheel can be replaced easily by swinging the web guide away.

In a further aspect of the present invention the web guide includes two integrally formed axle stubs snap-fitted into associated bores in the sidewalls of the base plate so that the web guide can be mounted on the base plate with ease.

In a further aspect of the present invention two flexible arms are provided at the end face of the web guide opposite its pivot bearing, each arm including a pin adapted to snap into associated bores in the sidewalls of the base plate so that the web guide can be releasably locked in its operating position in a simple manner. In addition, a platen of a print mechanism received in the casing for printing on the labels can be arranged on the base plate, which enables the platen to be readily exchanged together with the base plate.

In a further aspect of the present invention two shallow grooves for receiving friction rings are provided on the feed wheel in its generating surface adjacent to its end faces so that entrainment of the carrier web by the knobs on the feed wheel can be enhanced additionally by the mutual friction between carrier web and friction rings.

In a further aspect of the present invention the base plate includes in the area of the generating surface of the feed wheel a wall portion recessed cylindrically towards the outside so that the overall height of the base plate can be kept low.

In a further aspect of the present invention the detent spring is a raised and reinforced section of the recessed wall portion of the base plate, which section extend faces into the central annular recess of the feed wheel so that the detent spring can be manufactured easily in conjunction with the base plate.

In a further aspect of the present invention the radial projections are configured as rings of knobs at the axial ends of the generating surface so that a particularly reliable positive-engagement relationship between carrier web and feed wheel is ensured.

In a further aspect of the present invention axially opposite knobs have edges facing each other in a convex configuration, each with a contour corresponding to the arc of a circle having a radius of curvature shaped to conform to a corresponding radius of curvature of a wave-shaped longitudinal edge of the carrier web or an arc of an envelope circle of each recess in the longitudinal edge of the carrier web so that it is possible for one and the same feed wheel to handle carrier webs with variously shaped elevations and recesses.

In a further aspect of the present invention on axially neighboring knobs the circular arc merges into a knob flank at the location where the relative axial distance of two axially neighboring knobs is at a minimum, which knob flank is parallel to the axis of the feed wheel so that the knobs are adapted to make positive engagement with the outer edge of the carrier web, but only on that part of the edge that precedes them in the feed direction. This facilitates the process of threading the carrier web into the rings of knobs.

In a further aspect of the present invention the radial projections are constructed as rings of sprockets so that the labeling apparatus is able to handle carrier webs having cutouts in the form of slits for positive engagement with the sprockets.

In a further aspect of the present invention a slide is provided which is arranged in an opening in the base plate and adjustable in a direction transverse to the axis of the feed wheel, and the slide's outer surface which covers the opening is configured to be a guide surface for the carrier web so that it is possible, by adjusting the position of the slide, to adjust the length of travel of the carrier web between the position at which the labels are dispensed and the first pair of knobs with which the carrier web makes engagement. In this manner, it is possible for example, to match the position in which printing on the label is effected accurately to a preprinted image on a label by suitably adjusting the dispensing position. For this purpose, adjustment of the slide will cause its outer surface to protrude from the outer side of the base plate to a greater or lesser extent.

In a further aspect of the present invention the base plate mounts a guide roller for the carrier web, which roller is rotary about an axis parallel to the axis of the feed wheel so that the carrier web can be reliably directed onto the feed wheel on its advancing motion.

In a further aspect of the present invention the guide roller includes two integrally formed axle stubs snap-fitted into associated bores in sidewalls of the base plate so that the guide roller can be mounted and demounted just as easily as the feed wheel.

In one aspect of the label web according to the present invention the pitch of the longitudinal edges of the carrier web equals the label length so that the outer contour of the labels can be varied as desired with particular ease.

In another aspect of the label web according to the present invention the elevations and recesses of the lines of the longitudinal edges of the label web are of a sinusoidal, rectangular, trapezoidal or V-shaped configuration so that a wide range of options regarding the label shape is provided.

### BRIEF DESCRIPTION OF SEVERAL VIEWS OF THE DRAWINGS

The invention will be described in conjunction with the following drawings in which like reference numerals designate like elements and wherein:

FIG. 1 is an elevational view of a labeling apparatus according to the present invention comprising a first preferred embodiment of a base plate;

FIG. 2 is a view of the labeling apparatus of FIG. 1 showing additionally in a broken away representation the base plate in longitudinal section;

FIG. 3 is a view of the labeling apparatus of FIG. 1, showing the base plate swung away from the casing;

FIG. 4 is an exploded perspective view of those parts of the labeling apparatus that effect the drive of a feed pawl for a feed wheel rotatably mounted on the base plate;

FIG. 5 is a perspective view of the complete base plate;

FIG. 6 is a view of the base plate of FIG. 5, showing a web guide in swung open condition;

FIG. 7 is a perspective view of the base plate of FIGS. 5 and 6, absent all the moving parts thereof;

FIG. 8 is a plan view of the base plate of FIG. 5;

FIG. 9 is a longitudinal sectional view of the base plate taken along the line IX-IX of FIG. 8;

FIG. 10 is a perspective view of a slide representing a detail of the base plate of FIG. 9;

FIG. 11 shows in FIG. 11a first preferred embodiment of the feed wheel in an elevational view, in FIG. 11b the feed wheel in a sectional view taken along the line B-B of FIG. 11a, in FIG. 11c the feed wheel in an end view, in FIG. 11d the feed wheel in a longitudinal sectional view taken along the line D-D of FIG. 11c, in FIG. 11e as a detail E of FIG. 11a one of a plurality of knobs of the feed wheel, and in FIG. 11f the feed wheel in a perspective representation;

FIG. 12 shows in FIGS. 12a-12d, in like views as in FIGS. 11a-11d, a second preferred embodiment of the feed wheel comprising sprockets in lieu of knobs;

FIG. 13 is a perspective view of a guide roller; and

FIGS. 14 to 21 are views of variously shaped labels adapted to be handled with a labeling apparatus according to the present invention which includes a feed wheel with knobs, showing at a) three label webs arranged side-by-side as they are being manufactured and at b) one label as an individual representation.

### DETAILED DESCRIPTION OF THE INVENTION

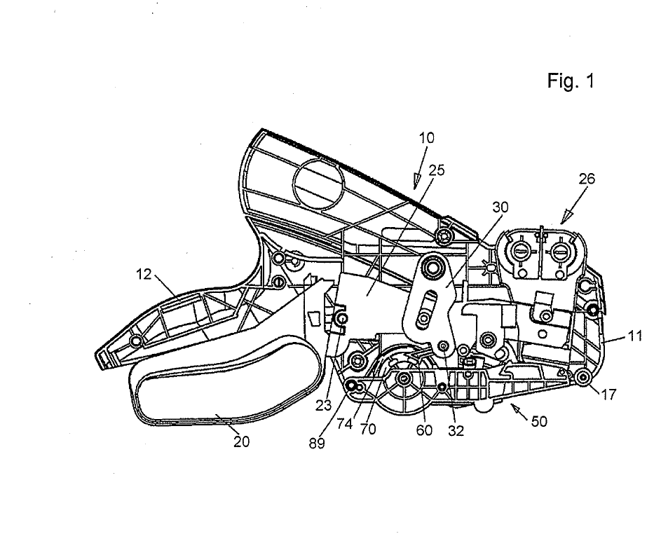

The labeling apparatus according to the present invention illustrated in FIGS. 1-3 and generally designated as 10 is similar in construction to a labeling apparatus according to the document DE 103 58 318 A1 initially cited, except for the construction of a base plate 50 carrying a feed mechanism, generally designated as 40, for a carrier web 15, and except for a feed pawl 60 which is pivotable through intermediate members by an operating lever 20 of the labeling apparatus 10. Therefore, with the exception of the base plate 50 with its feed mechanism 40, the labeling apparatus 10 will be described with reference to FIGS. 1-4 only to the extent necessary for an understanding of the present invention. The remaining figures will be described subsequently, illustrating the base plate 50 with the feed mechanism 40 arranged on it and a label web in detail.

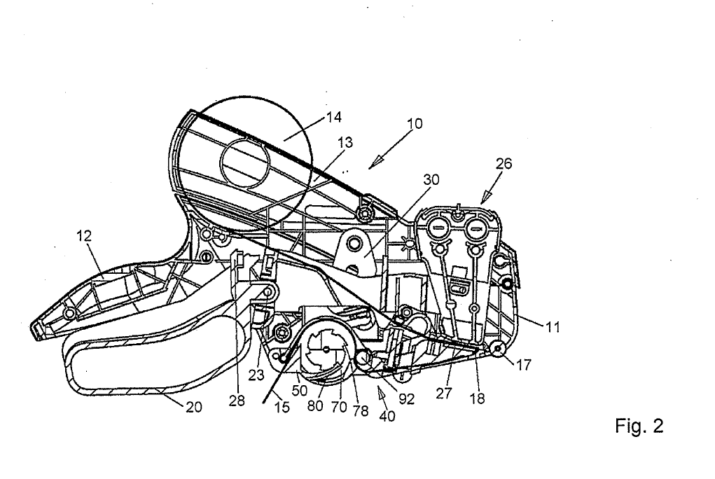

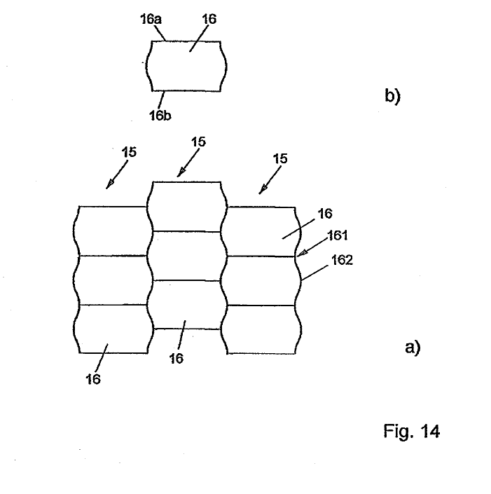

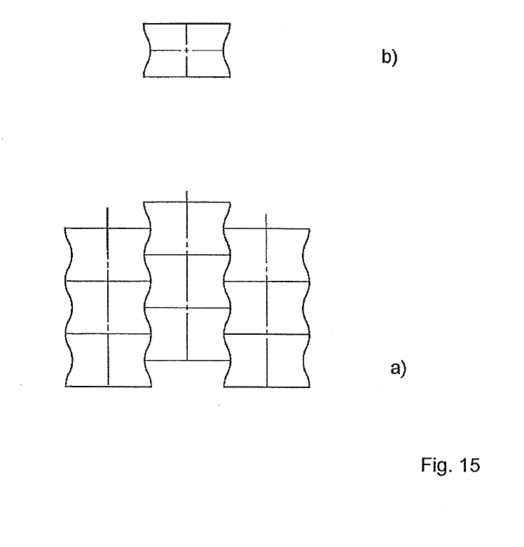

The labeling apparatus 10 illustrated in FIGS. 1-3 includes a casing 11 formed of two plastic shells fitted together and having a handle 12 formed thereon. On the casing upper side is a bay 13 for receiving a supply roll 14 (FIG. 2) of a carrier web 15 (FIG. 14a) to which self-adhesive labels 16 (FIG. 14b) are adhered. The carrier web 15 is routed in the labeling apparatus 10 from the supply roll 14 in the bay 13 to the bottom right in the representation of FIG. 2 to a dispensing lip 18 where the carrier web 15 is turned around to be routed through the feed mechanism 40 to the rear end face of the casing 11. Opposite the dispensing lip 18, an applicator roll 17 is rotatably mounted in the casing 11 in order to enable a label delaminated from the carrier web 15 at the dispensing lip 18 and occupying a dispensing position to be adhered to an object by a rolling motion of the applicator roll 17.

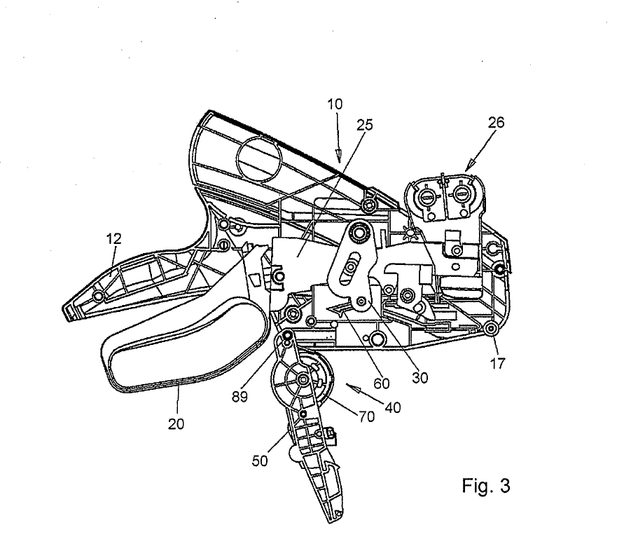

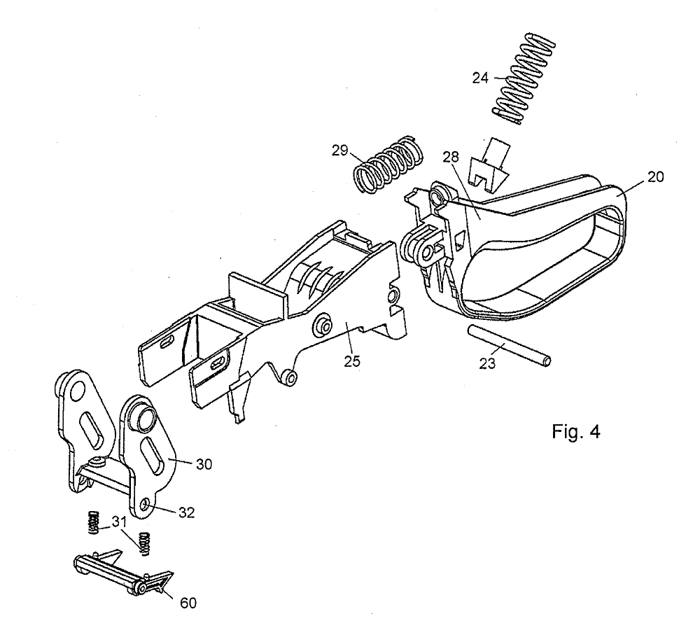

Beneath the handle 12 the labeling apparatus 10 includes an operating lever 20 mounted on the casing 11 for pivotal motion about an axis 23. According to the representation of FIG. 4, a spring 24 is seated between the operating lever 20 and a print mechanism lever 25 to urge the operating lever 20 into a rest position as shown in FIG. 3. The print mechanism lever 25 is likewise mounted for pivotal motion about the axis 23. The print mechanism lever 25 supports a print mechanism 26 to enable a self-adhesive label 16 resting on a platen 27 to be printed. Seated between the operating lever 20 and the print mechanism lever 25 is a spring 29 (FIG. 4) serving to transmit a movement of the operating lever 20 against the handle 12 to the print mechanism lever 25. In the rest position shown in FIG. 3, the print mechanism lever 25 is held in a raised position by the operating lever 20.

In contrast to the labeling apparatus known from DE 103 58 318 A1 which provides a transport slide slidably mounted in the casing 11, the feed mechanism 40 includes a feed wheel 70 rotatably mounted on the base plate 50, which feed wheel uses knobs 74 to make positive engagement with the carrier web 15 for advancing it, as will be described in more detail further below in conjunction with the base plate 50. Moreover, unlike the labeling apparatus known from DE 103 58 318 A1, the dispensing lip 18, instead of being a front part of the casing 11, is formed by the front edge of the base plate 50.

For a brief description of an operating cycle of the labeling apparatus 10 illustrated in FIGS. 1-4, it is assumed that no self-adhesive label as yet occupies the dispensing position underneath the applicator roll 17. To initiate an operating cycle, the operating lever 20 is pulled towards the handle 12 as a result of which the print mechanism lever 25, owing of the effect of an arm 28 and the spring 29, is pivoted counterclockwise about the axis 23, thereby causing the print mechanism 26 to be lowered onto the platen 27 on the base plate 50. On impact with the platen 27, the print mechanism 26 produces a print on the self-adhesive label 16 resting on the platen 27 at this particular instant. Via a lever 30 also pivotably mounted on the casing 11 but driven by the print mechanism lever 25, on each actuation of the operating lever 20 the feed wheel 70 is rotated through one increment by means of a feed pawl 60, thereby causing the carrier web 15 to be moved towards the platen 27. When the operating lever 20 is released, the spring 24 returns the operating lever 20 to the initial position shown in FIG. 3, in which process the operating lever 20 pivots the print mechanism lever 25 clockwise about the axis 23. At the same time, the feed pawl 60 is moved back into engagement with the feed wheel 70, as will be also explained in greater detail further below. As this occurs, the label web is pulled around the dispensing lip 18, whereby one self-adhesive label 16 delaminates itself from the carrier web 15 at the dispensing lip 18 and reaches the position underneath the applicator roll 17. The self-adhesive label 16 is now ready for being adhered to an object by the rolling motion of the applicator roll 17. Springs 31 (FIG. 4) urge the lever 30 into its initial position. The feed pawl 60 is pivoted to the lever 30 on an axis 32. A more detailed description of the base plate 50 and the feed wheel 70 will be given in the following.

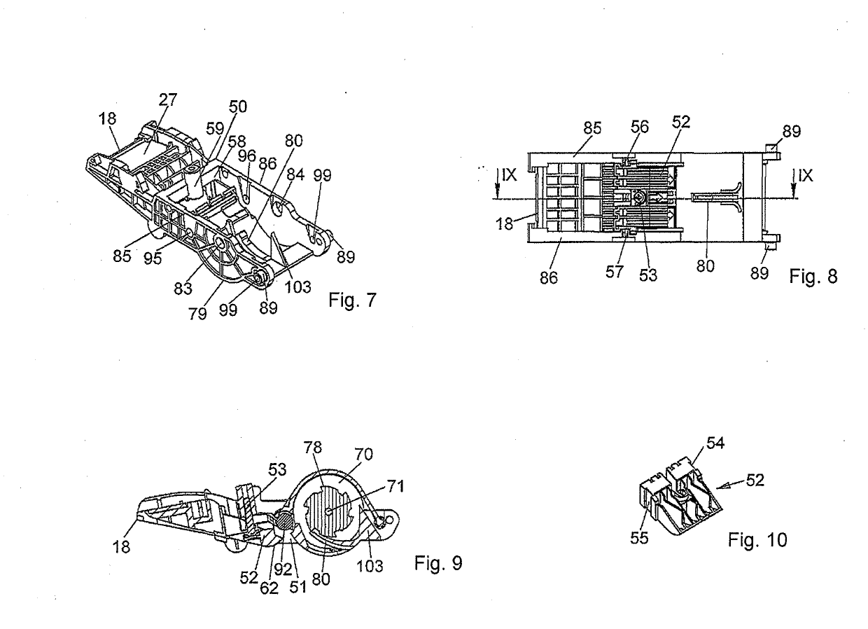

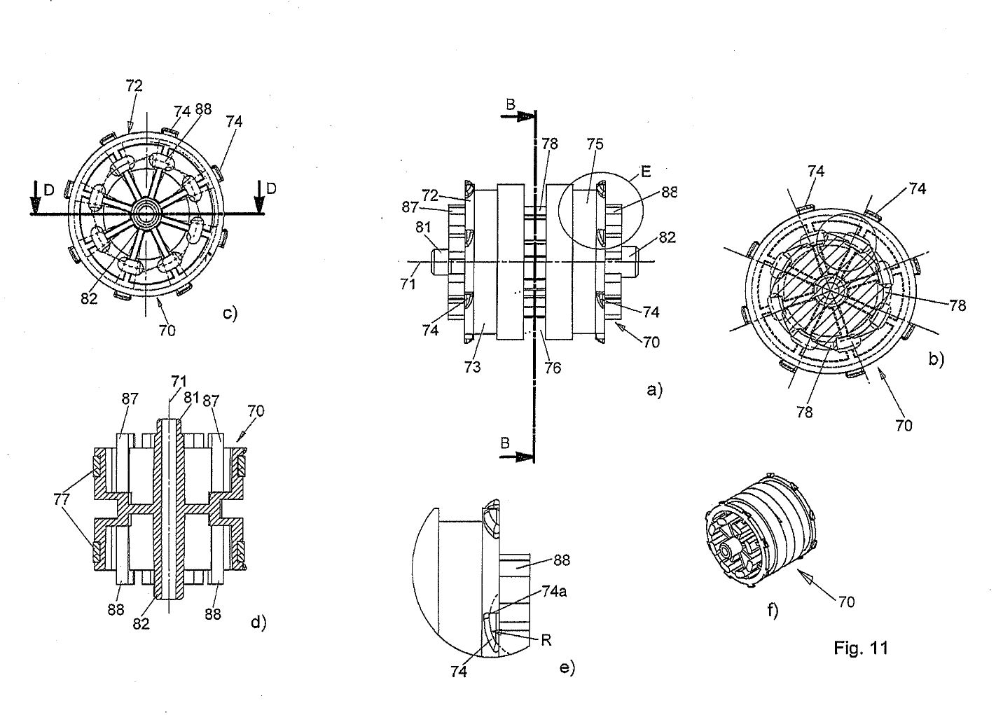

FIG. 11a shows a first preferred embodiment of the feed wheel 70 in an elevational view. The feed wheel 70 has in its generating surface 72 a central annular recess 76. Formed in the recess 76 is a ring of cams 78 as becomes apparent from FIG. 11b showing a section taken along the line B-B of FIG. 11a. The cams 78 are part of a return stop for the feed wheel 70, which return stop comprises, in addition to the cams 78 provided on the feed wheel 70, a detent spring 80 protruding from the base plate 50 and resiliently engageable with the cams, as best shown in FIGS. 7 to 9. FIG. 2 shows the cooperative relationship between the detent spring 80 and the cams 78. The representation of FIG. 2 shows that the feed wheel 70 is rotatable counterclockwise, with the detent spring 80 being resiliently disengaged by each cam 78 until it engages the feed wheel 70 again behind a cam 78, thereby preventing the feed wheel 70 from rotating clockwise and hence the carrier web 15 from being fed back. The detent spring 80 is a spring arm formed on the base plate 50.

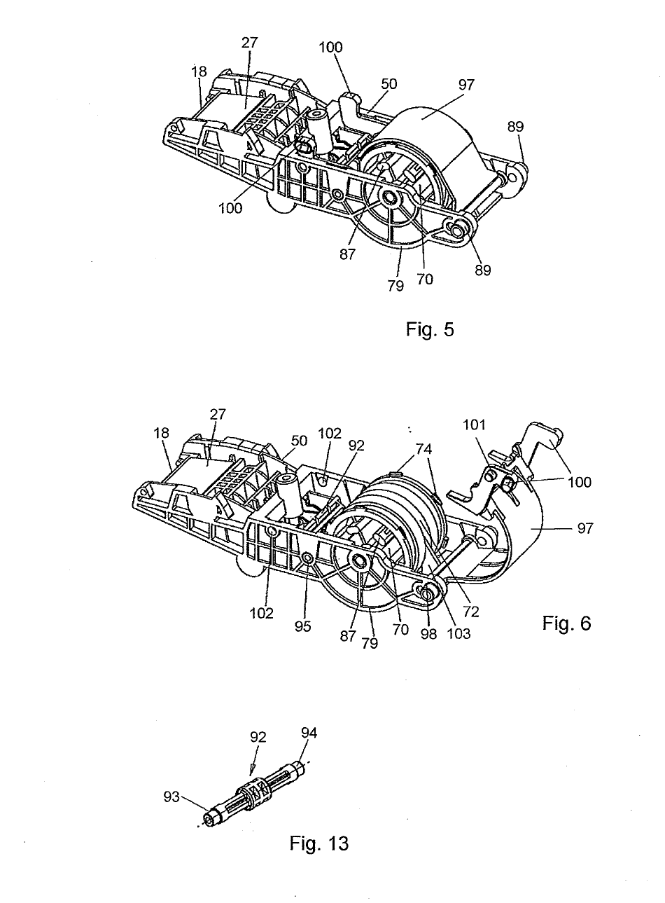

Furthermore, according to the representation of FIG. 11 the feed wheel 70 includes at its end faces axle stubs 81, 82 of different diameter which are snap-fitted into associated bores 83, 84 (FIG. 7) in mutually opposite sidewalls 85, 86 of the base plate 50, as becomes apparent from FIGS. 5 and 6. In addition, the feed wheel 70 includes in its generating surface 72 adjacent to its end faces two shallow grooves 73, 75 for receiving friction rings 77 indicated in section only in FIG. 11d which is a longitudinal sectional view of the feed wheel 70 taken along the line D-D of FIG. 11c. At its two axial end faces the feed wheel 70 has a respective ring of axial pins 87 and 88 which are engageable by the feed pawl 60 pivotable by the operating lever 20 in order to rotate the feed wheel 70 through one increment on each actuation of the operating lever 20.

The knobs 74 are axially opposed to each other and have mutually facing edges shaped in a convex configuration, each with the contour of a circular arc of a curvature radius R (indicated in FIG. 11e as detail E of FIG. 11a) which is shaped to conform with a corresponding curvature radius of a wave-shaped outer edge of the carrier web 15 (FIG. 13a) or an arc H of an envelope circle of each recess in the carrier web 15 (FIG. 15a).

On axially neighboring knobs 74 the circular arc merges into a knob flank 74a at the location where the relative axial distance of two neighboring knobs is at a minimum, which knob flank is parallel to the axis 71 of the feed wheel 70, as best seen in FIG. 11e.

The base plate 50 is configured as an interchangeable base plate which is selectable in dependence upon the phase relationship between the rings of knobs 74 and the rings of pins 87, 88 on the feed wheel 70. The structure of the base plate 50 will now be further described with reference to FIGS. 5-13. The base plate 50 includes at one end face two integrally formed axle stubs 89 which are adapted to be snap-fitted into associated casing bores in the two mutually opposite sidewalls 85, 86 of the casing 11 and are rotatable in said casing bores for swinging the base plate 50 open. FIG. 3 shows the base plate in swung-open condition. The base plate 50 mounts a guide roller 92 (FIG. 13) for the carrier web 15, which guide roller is rotary about an axis parallel to the axis of the feed wheel 70. The guide roller 92 includes two integrally formed axle stubs 93, 94 which are snap-fitted into associated bores 95 and 96, respectively, in the sidewalls 85, 86 of the base plate 50 (FIG. 7). Furthermore, the base plate 50 pivotally mounts a web guide 97 which covers the feed wheel 70 in a semicircle and is adapted to be swung away from the feed wheel 70, as shown in FIGS. 5 and 6.

The web guide 97 includes two integrally formed axle stubs 98 snap-fitted into associated bores 99 in the sidewalls 85, 86 of the base plate 50 (FIGS. 6 and 7). At the end face of the web guide 97 remote from its pivot bearing two flexible arms 100 are formed, each mounting a respective pin 101. Each pin 101 is adapted to be snap-fitted into an associated bore 102 in the sidewalls 85, 86 of the base plate 50. The base plate 50 further mounts the above-referenced platen 27 of the print mechanism 26 accommodated in the casing 11 for printing on the labels 16. Furthermore, the inner side of the base plate 50 includes a deflector 103 configured to extend face obliquely upwardly into the central annular recess 76 of the feed wheel 70 (FIGS. 6-8). The deflector 103 serves an additional guiding function for the carrier web 15. In the area of the generating surface 72 of the feed wheel 70 the base plate 50 is provided with a wall portion 79 cylindrically recessed outwardly. The detent spring 80 is a raised and reinforced section of the recessed wall portion 79 of the base plate 50, which raised section extend faces into the central annular recess 76 of the feed wheel 70, as best seen in FIG. 9. The base plate 50 and all the parts mounted on it and described up to this point are injection-molded parts fabricated from a plastic.

According to the representation of FIGS. 8 and 9, an opening 51 in the base plate 50 receives a slide shown in FIG. 10 as a detail and generally designated as 52, which is adjustable in a direction transverse to the axis 71 of the feed wheel 70 by means of a self-tapping screw 53. The slide 52 is equally an injection-molded component provided with grooves 54, 55 on opposite sides for engagement with guide ribs 56, 57 integrally formed on the sidewalls 85, 86 of the base plate 50. The screw 53 is movable with its head in the slide 52, but held captive therein, as becomes apparent from FIG. 9. According to the representation of FIG. 7, the base plate 50 includes between its sidewalls 85, 86 an integrally formed partition wall 58 having in its center an integrally formed bushing 59 in which the self-tapping screw 53 is threadedly received. The outer surface 62 of the slide 53 covering the opening 51, that is, its bottom surface as seen looking at FIGS. 9 and 10, provides a guide surface for the carrier web 15. The route of the carrier web in the area of the base plate 50 is shown in FIG. 2. When the carrier web 15 travels past the dispensing lip 18, paying out one of the labels 16, it moves along the lower outside of the base plate 50 and the outer surface 62 of the slide 52 to enter a gap between the guide roller 92 and the feed wheel 70. The latter entrains with its knobs 74 the carrier web 15 by positive engagement to ultimately deliver it to the outside through the deflector 103. The length of travel of the carrier web 15 between the dispensing lip 18 and the first pair of knobs engaging is adjustable by adjusting the slide 52.

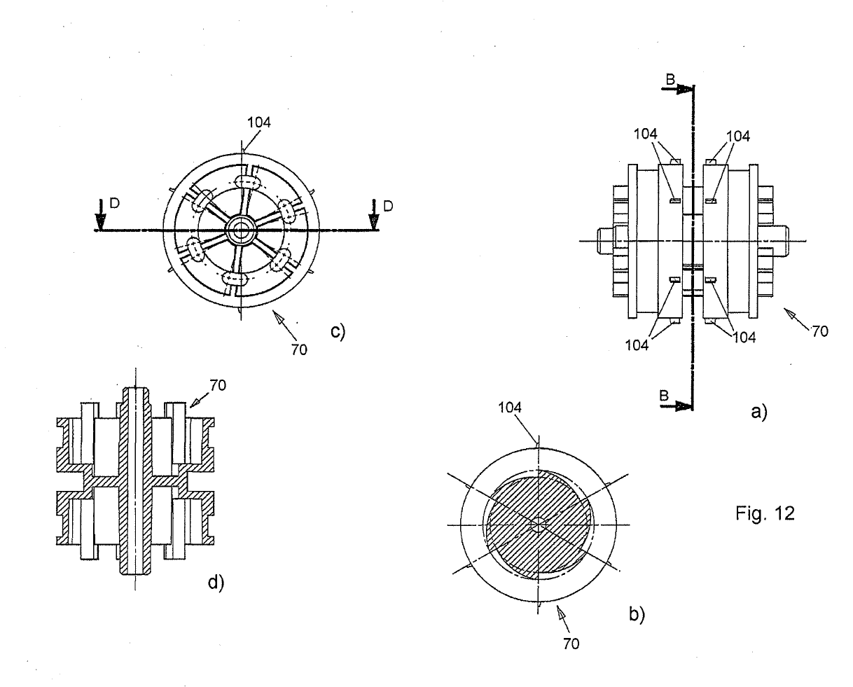

FIGS. 12a-12d show in like views as in FIGS. 11a-11d a second embodiment of the feed wheel 70 which differs from the feed wheel 70 of FIG. 11 only in that it comprises, in lieu of two rings of knobs 74, two rings of sprockets 104 as radial projections. The two rings of sprockets 104 are arranged at the two mutually opposite edges of the recess 76 of the feed wheel 70 on its generating surface. The construction of the feed wheel 70 equipped with the sprockets 104 being otherwise identical to the construction of the feed wheel 70 provided with the knobs 74, there is accordingly no need to discuss the construction of the feed wheel 70 of FIG. 12 in greater detail. The sprockets 104 are adapted to make positive engagement with a carrier web which, in lieu of or in addition to the elevations and recesses on its longitudinal edges 162, includes sated cutouts between its longitudinal edges into which the sprockets 104 can engage for a positive-engagement advancing motion of the carrier web.

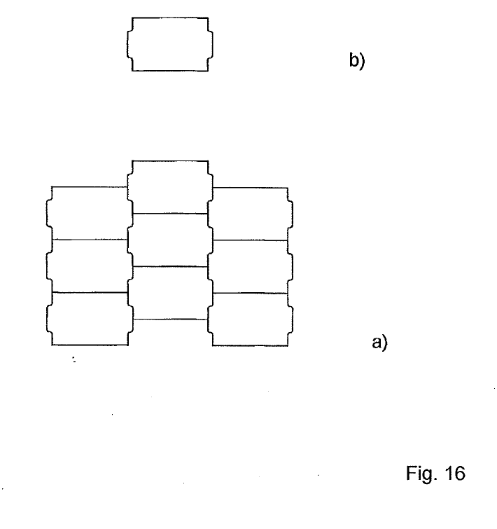

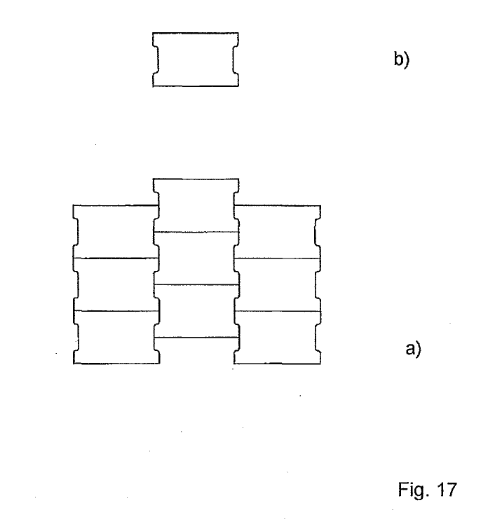

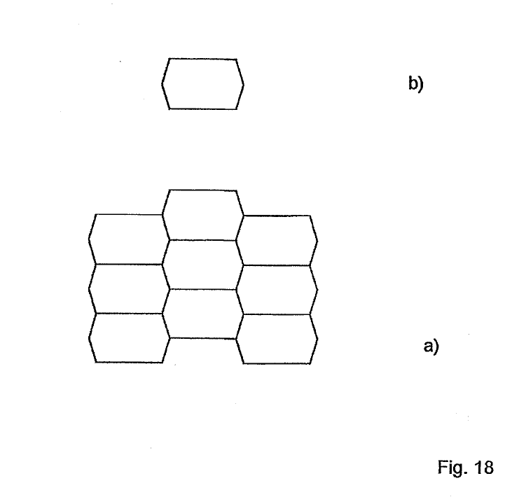

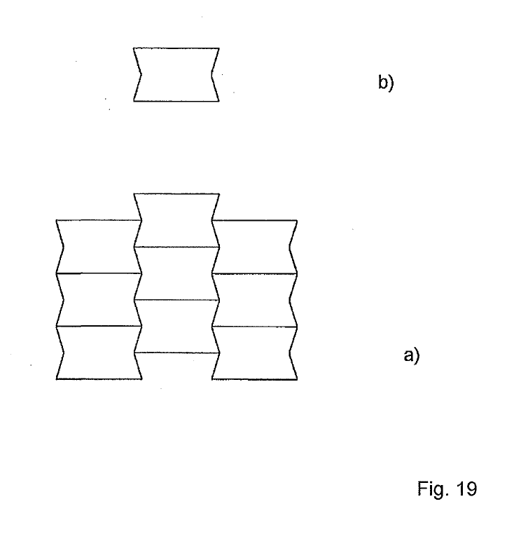

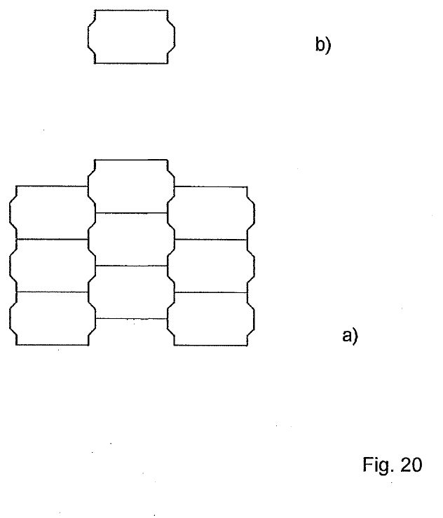

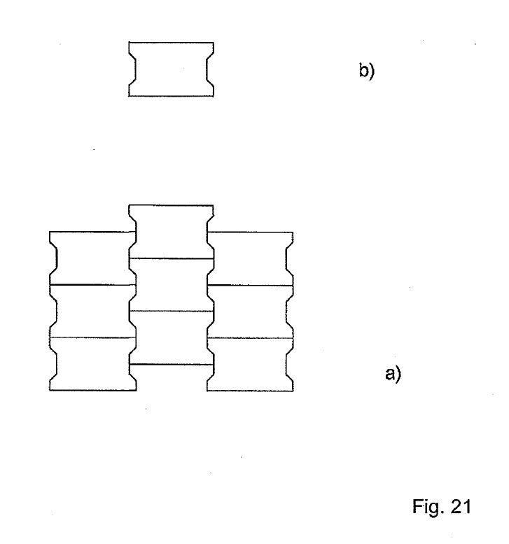

A label web for the labeling apparatus 10 with the base plate 50 and the feed wheel 70 provided with the knobs 74 will now be described in more detail with reference to FIGS. 14-21. The label web comprises the carrier web 15 and the self-adhesive labels 16 arranged on it. The two longitudinal edges 162 of the label web are configured to be continuous lines of opposite phase with like elevations and recesses alternating at regular intervals, with the elevations and recesses lying opposite each other in pairs across the width of the label web, as becomes readily apparent from FIGS. 14-21. The phase relationship of the pitch of the carrier web 15 to the pitch of the strip of individual labels 16 arranged on the carrier web is chosen in such a way that each pair of recesses of the carrier web lies in the center between two straight and parallel boundary lines of each label 16 extend facing in a direction transverse to the longitudinal direction of the carrier web 15, as shown in FIGS. 15, 17, 19 and 21 for label webs having variously shaped longitudinal edges, including elevations and recesses of the lines of the longitudinal edges which are of a sinusoidal (FIGS. 14 and 15), rectangular (FIGS. 16 and 17), V-shaped (FIGS. 18 and 19) or trapezoidal (FIGS. 20 and 21) configuration. FIGS. 14, 16, 18 and 20 show label strips with known shapes of label, yet equally handleable by the labeling apparatus 10, provided that the phase relationship of the pitch of the carrier web 15 to the pitch of the strip of individual labels arranged on the carrier web 15 is chosen such that each pair of elevations of the carrier web 15 lies in the center between two straight and parallel boundary lines of each label 16 which extend face in a direction transverse to the longitudinal direction of the carrier web 15. In all cases, the pitch of the lines of the longitudinal edges 162 of the carrier web 15 is equal to the label length.

### LIST OF REFERENCES

10 labeling apparatus
11 casing
12 handle
13 bay
14 supply roll
15 carrier web
16 self-adhesive labels
16a boundary line
16b boundary line
17 applicator roll
18 dispensing lip
20 operating lever
23 axis
24 spring
25 print mechanism lever
26 print mechanism
27 platen
28 arm
29 spring
30 lever
31 spring
32 axis
40 feed mechanism
50 base plate
51 opening
52 slide
53 screw
54 groove
55 groove
56 guide rib
57 guide rib
58 transverse wall
59 bushing
60 feed pawl
62 outer surface
70 feed wheel
71 axis
72 generating surface
73 groove
74 knob
74a knob flank
75 groove
76 recess
77 friction rings
78 cam
79 wall portion
80 detent spring
81 axle stub
82 axle stub
83 bore
84 bore
85 sidewall
86 sidewall
87 pins
88 pins
89 axle stub
92 guide roller
93 axle stub
94 axle stub
95 bore
96 bore
97 web guide
98 axle stub
99 bores
100 arms
101 plug
102 bore
103 deflector
104 sprockets
161 recesses
162 longitudinal edges
163 deflector
H arc of envelope circle
R radius

While the invention has been described in detail and with reference to specific examples thereof, it will be apparent to one skilled in the art that various changes and modifications can be made therein without departing from the spirit and scope thereof.

What is claimed is:

1. A labeling apparatus for dispensing and applying self-adhesive labels arranged on a carrier web, said labeling apparatus comprising:
a feed wheel that is rotatably mounted on a base plate of said labeling apparatus and drivable in increments by an operating lever pivotally mounted on a casing of said labeling apparatus, said feed wheel displacing the carrier web, said feed wheel having a peripheral surface comprising at least one ring of radial projections for positive engagement with the carrier web and wherein said feed wheel comprises at both its ends a ring of axial pins engageable by a feed pawl pivotal by said operating lever;
said base plate being pivotally mounted within said labeling apparatus to be swung away from said casing;
wherein said radial projections are provided in two axially spaced rings on said peripheral surface of said feed wheel, said projections lying opposite each other in pairs and for making positive engagement with recesses or cutouts in the carrier web; and
wherein said base plate is interchangeable and is selectable depending upon a phase relationship of the rings of projections to the rings of pins of said feed wheel.

2. The labeling apparatus of claim 1 wherein said base plate comprises a return stop for said feed wheel, said return stop comprising cams formed on said feed wheel and wherein a detent spring protrudes from said base plate and is engageable with said cams.

3. The labeling apparatus of claim 2 wherein said feed wheel has in its generating surface a central annular recess in which said cams are formed at the bottom.

4. The labeling apparatus of claim 3 wherein an inner side of said base plate includes at least one deflector for the carrier web, and wherein said at least one deflector extends obliquely upwardly into a central annular recess of said feed wheel.

5. The labeling apparatus of claim 2 wherein said base plate includes two axle stubs integrally formed at one end of said base plate, said stubs being snap-fittable into associated bores in mutually opposite sidewalls of said casing and which are rotatable in said bores for swinging said base plate away.

6. The labeling apparatus of claim 5 wherein said feed wheel includes axle stubs at its ends which are snap-fitted into associated bores in sidewalls of said base plate.

7. The labeling apparatus of claim 2 wherein said base plate pivotally mounts a web guide which covers said feed wheel in a semicircle and is adapted to be swung away from said feed wheel.

8. The labeling apparatus of claim 7 wherein said web guide includes two integrally formed axle stubs which are snap-fitted into associated bores in sidewalls of said base plate.

9. The labeling apparatus of claim 7 wherein two flexible arms are provided at an end of said web guide opposite its pivot bearing, each of said arms including a plug snapped into associated bores in sidewalls of said base plate.

10. The labeling apparatus of claim 2 wherein two shallow grooves for receiving friction rings are provided on said feed wheel in a generating surface adjacent its end faces.

11. The labeling apparatus of claim 10 wherein said base plate includes in an area of said generating surface of said feed wheel a wall portion recessed cylindrically towards an outside of said feed wheel.

12. The labeling apparatus of claim 3 wherein said detent spring is a raised and reinforced section of the recessed wall portion of said base plate, which section extends into the central annular recess of the feed wheel.

13. The labeling apparatus of claim 2 wherein said radial projections are configured as rings of knobs at the axial ends of the generating surface.

14. The labeling apparatus of claim 13 wherein said axially opposite knobs have edges facing each other in a convex configuration, each with a contour corresponding to the arc of a circle having a radius of curvature (R) shaped to conform to a corresponding radius of curvature of a wave-shaped longitudinal edge of the carrier web or an arc (H) of an envelope circle of each recess in the longitudinal edge of the carrier web.

15. The labeling apparatus of claim 14 wherein on axially neighboring knobs the circular arc merges into a knob flank at the location where the relative axial distance of two axially neighboring knobs is at a minimum, which knob flank is parallel to the axis of the feed wheel.

16. The labeling apparatus of claim 2 wherein said radial projections are constructed as rings of sprockets.

17. The labeling apparatus of claim 1 wherein a slide is arranged in an opening in said base plate and is adjustable in a direction transverse to the axis of said feed wheel, with said slide's outer surface which covers the opening being configured to be a guide surface for the carrier web.

18. The labeling apparatus of claim 1 wherein said base plate mounts a guide roller for said carrier web, which roller is rotary about an axis parallel to the axis of said feed wheel.

19. The labeling apparatus of claim 18 wherein said guide roller includes two integrally formed axle stubs snap-fitted into associated bores in sidewalls of said base plate.

20. A label web for use in a labeling apparatus having a base plate, said label web comprising a carrier web and with self-adhesive labels adhered thereto in series arrangement, wherein at least two longitudinal edges of said label web are configured to be continuous lines of opposite phase with like elevations and recesses alternating at regular intervals, and in which said elevations and recesses lie opposite each other in pairs across the width of said label web, and wherein a phase relationship of the pitch of the carrier web to the pitch of the strip of individual labels arranged on said carrier web is chosen such that each pair of recesses of the carrier web lies in the center between two straight and parallel boundary lines of each label which extend in a direction transverse to a longitudinal direction of said carrier web.

21. The label web according to claim 20 wherein a pitch of the longitudinal edges of the carrier web equals the label length.

22. The label web according to claim 20 wherein elevations and recesses of the lines of longitudinal edges of said label web are of a sinusoidal, rectangular, trapezoidal or V-shaped configuration.
